(19) United States
(12) Patent Application Publication
(10) Pub. No.: US 2003/0178883 A1
(43) Pub. Date: Sep. 25, 2003

(54) Body support assembly for an off-highway truck

(76) Inventors: James R. Hinds, Taylorville, IL (US); Theodore A. Moutrey, Taylorville, IL (US)

Correspondence Address: CATERPILLAR INC., 100 N.E. ADAMS STREET, PATENT DEPT., PEORIA, IL, 616296490

(21) Appl. No.: 10/103,404

(22) Filed: Mar. 21, 2002

(51) Int. Cl. B60P 1/04

(52) U.S. Cl. 298/17 R

(57) ABSTRACT

The present invention provides a dump body having a box portion and a skeletal structure. The dump body includes a body support assembly for pivotally attaching the dump body to the frame of the truck. The body support assembly includes a base member and a first and second body support member attached to the base member. The first and second body support members each include a bore adapted receive a steel pin. The body support assembly of the present invention provides a dump body that can be manufactured without the need to line bore the pin bores after welding of the dump body has been completed.

### TECHNICAL FIELD

This invention relates generally to off-highway trucks and more specifically to a body support assembly for a dump body.

### BACKGROUND

Large off-highway trucks, such as those used in the mining and heavy construction industries are manufactured using a large number of weldments. Examples of two such weldments include the frame and dump body. Although the size of these weldments is quite large, they often include features having very close tolerances. In order to manufacture these weldments and maintain the close tolerances, a secondary machining operation may be required. Accomplishing these secondary operations typically requires movement of the weldment within the shop to a specialized machining area. The need for these secondary operations increases the expense of manufacturing. Additionally, if components utilizing these secondary operations require repair during the life of the body, repair costs are likely to be expensive.

One weldment having such a problem is a dump body. The dump body includes a pair of body support members that are located near a rear portion of the dump body. The body support members act to pivotally attach the dump body to the truck frame. Each body support member includes a pin bore that must align with a mating pin bore on the truck frame. Because of the large size of the body weldment, there is a great deal of distortion caused by the welding. This distortion is likely to cause miss-alignment of the pin bores, therefore requiring the secondary machining operation of line boring.

Line boring large components is a time consuming and complicated process, even if done in a factory setting. Line boring becomes even more difficult and expensive when it is done in the field. Should body supports need field repair, a boring machine must be delivered and assembled on site. The added expense of working in the field is difficult to justify for the repair of a single truck body.

The present invention is intended to overcome one or more of the above identified problems.

### SUMMARY OF THE INVENTION

The present invention provides a body support assembly for an off-highway truck. The body support assembly includes a base member adapted to be attached to an underside of a track body. A first body support member having a pin bore is attached to the base member at a position nearest a first side portion. A second body support member having a pin bore is attached to the base member at a position nearest a second side portion. The second body support member is fixedly attached to the base member such that the pin bores are aligned along a single axis.

In another aspect of the present invention, a method for repairing one of a first or second body support member one a dump body is provided. The method includes removing a first and second body support member from the dump body and providing a new body support assembly. The body support assembly includes new first and second body support members. The dump body is then prepared to receive the body support assembly and the body support assembly to is attached to the dump body.

### BRIEF DESCRIPTION OF THE DRAWINGS

FIG. 1 is a side view of a truck employing the body support assembly of the present invention.

FIG. 2 is a perspective view of the truck body employing one embodiment of the body support assembly of the present invention.

FIG. 2b is an enlarged perspective view of the body support assembly of FIG. 2.

FIG. 3 is a perspective view of the truck body employing another embodiment of the body support assembly of the present invention.

FIG. 3b is an enlarged perspective view of the body support assembly of FIG. 3.

### DETAILED DESCRIPTION

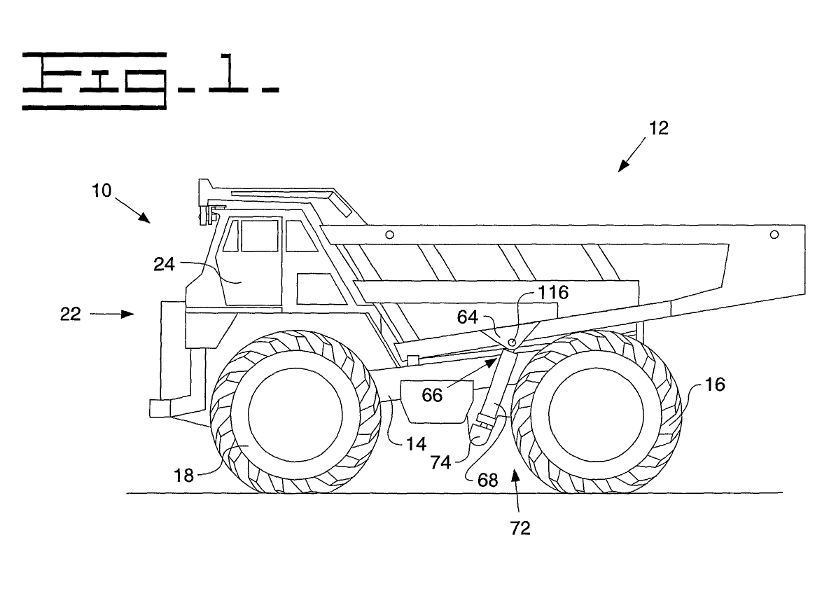

Referring to FIG. 1, an off-highway truck 10 having a dump body 12 employing the present invention is provided. The truck 10 includes a frame 14 having a plurality of rear wheels 16 and a pair of front wheels 18. An engine compartment 22 and an operators cab 24 are mounted at one end of the frame 16. An engine (not shown) and a transmission (not shown) are mounted within the engine compartment 22 and are drivingly coupled to the rear wheels 16.

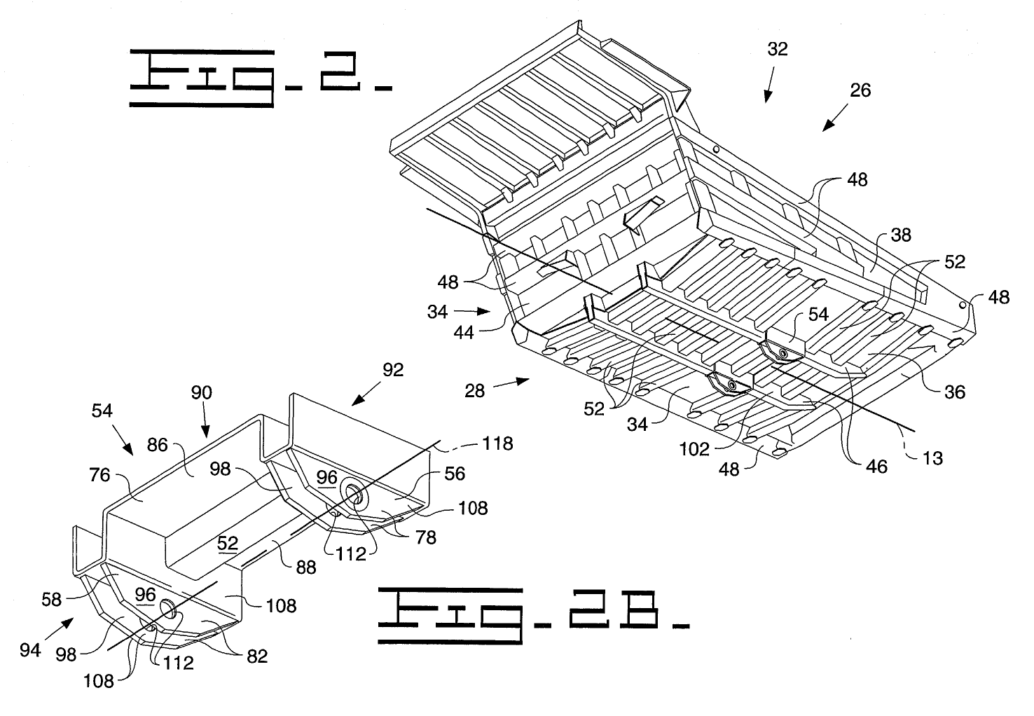

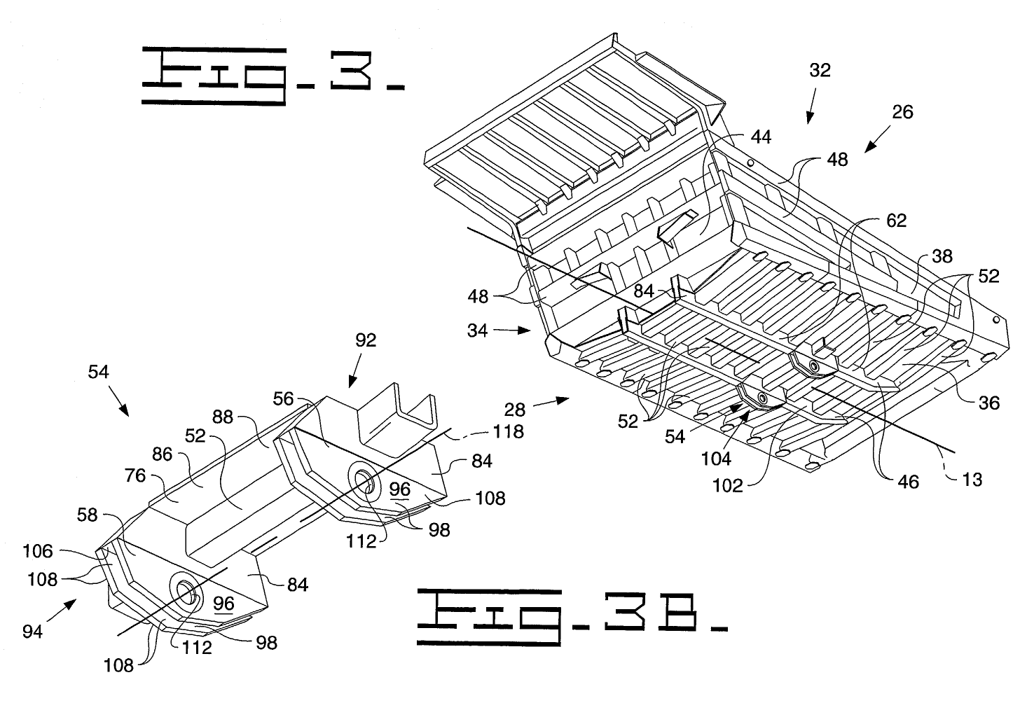

Referring now to FIGS. 2 and 3, the dump body 12 is defined about a longitudinal central axis 13 and includes a box portion 26 and a skeletal structure 28. The dump body 12 is typically made of steel, but may alternatively be made of any other suitable material, such as aluminum. The box portion 26 defines an inside surface 32 and an outside surface 34. The box portion 26 includes a floor 36, a first side wall 38, a second side wall (not shown) and a front wall 44 positioned between the first and second sides walls 38,42. A tailgate (not shown) may be provided to prevent payload from spilling from the dump body 12 during transport. The tailgate is adapted to move between an open position and a closed position.

The skeletal structure 28 includes a pair of stringers 46, a plurality of longitudinal ribs 48 and a plurality of transversal ribs 52. Each of the pair of stringers 46 is spaced an equal distance to the left and right of the longitudinal central axis 13. The stringers 46 attach to the outside surface 34 of the box portion 26, preferably by welding. The longitudinal ribs 48 typically traverse the front wall 44 and side walls 38,42. The transversal ribs 52 extend between the longitudinal ribs 48 and stringers 46. The transversal ribs 52 are typically oriented perpendicular to the longitudinal ribs 48 or stringers 46, although orientation may vary. The stringers 46, longitudinal ribs 48 and transversal ribs 52 are typically formed from sheet metal and define a “C” shaped cross section. A number of alternate cross-sectional shapes may be used without deviating from the present invention.

Portions of the skeletal structure 28 near the a body support assembly 54 may be adapted to be separately assembled or included in the body support assembly 54. For example, each stringer 46 typically receives one of a first or second body support member 56,58. Alternatively, the stringers 46 may be provided in multiple sections 62 as shown in FIGS. 3 and 3b.

The dump body 12 is pivotally attached to the frame 14 by the body support assembly 54. The body support assembly 54 is located on the outside surface 34 of the box portion 26, toward the rear of the dump body 12. A first pair of cylinder brackets 64 (shown in FIG. 1) are also provided on the outside surface 34 of the box portion 26. The first pair of cylinder brackets 64 are positioned toward the front of the dump body 12. Each of the first pair of cylinder brackets 64 is adapted to receive a first end 66 of one of a pair of hydraulic cylinders 68. A second pair of cylinder brackets 72 are provided on the frame 14 and are adapted to receive a second end 74 of each hydraulic cylinder 68. The hydraulic cylinders 68 are moveable between a retracted position (shown) and an extended position (not shown). In the extended position the front of the dump body 12 is raised for ejecting the payload. In the retracted position the dump body 12 is down for receiving payload.

Referring now to FIGS. 2b and 3b, the body support assembly 54 of the present invention is shown. The body support assembly 54 may be constructed from fabricated steel members, as shown, or from one or more castings. The body support assembly 54 includes a base member 76 having a first side portion 92 having a first body support member 78, a second side portion 94 having a second body support member 82. The body support assembly 54 may include a connecting member 88 or transversal ribs 52 extending between and connected to each of the first side portion 92 and the second side portion 94. One or more gussets (not shown) may be arranged an fastened to the body support assembly to provide additional strength.

The body support assembly 54 is adapted to fasten to the outside surface 34 of the box portion 26, typically by welding. The body support assembly 54 may include stringer portions 84 and transversal ribs 52 fastened to the base member 76.

The base member 76 may be a substantially flat steel plate 86 as shown in FIG. 3b. Alternately, the base member may be formed to interfit at least one of the stringers 46 and transversal ribs 52, as shown in FIG. 2b. The steel plate 86 is substantially rectangular in shape and includes an exterior surface 88 and an opposing surface 90 spaced a predetermined distance from the exterior surface 88. The base member 76 also defines a first side portion 92 on the exterior surface 88 and a second side portion 94, opposite the first side portion 92. The opposing surface 90 of the base member 76 is adapted to interface the outside surface 34 of the box portion 26. The base member 76 may further be fastened to the dump body 12 through welding or any conventional fastening method.

As shown in FIG. 3b, the body support assembly 54 may include stringer portions 84 that are positioned to interfit multiple sections 62 of the stringers 46. The stringer portions 84 are adapted to align with one another and be welded together to creating a single stringer 46. Alternatively, the stringer portions 84 may be joined using other joining methods, such as a flanged and bolted joints.

Each of the first body support member 78 and second body support member 82 include a first plate 96 and a second plate 98. The first and second plates 96,98 extend from the base member 76. As illustrated, the first and second plates 96,98 are spaced apart from one and other to be positioned near a first and second side 102,104 of the stringer portion 84. As an alternative, a spacer 106 may be positioned between the first and second plates 96,98, allowing the body support members 78,82 to be attached to the stringer portion 84. Each of the first and second plates 96,98 define a pair of side surfaces 108. A bore 112 is defined in each of the pair of plates 96,98, the bore 112 extends from one of the pair of side surfaces 108 to the other of the pair of side surfaces 108. The bore 112 is preferably machined after the body support assembly 54 is completely assembled, and adapted to align with a pair of frame bores (not shown). The bores 112 are adapted to receive a steel bushing and a steel pin 116. The pins 116 and bores 112 may include grease fittings to facilitate lubrication of the pivotal joint.

### INDUSTRIAL APPLICABILITY

A dump body 12 for an off-highway truck 10 having a body support assembly 54 of the present invention is assembled in the following manner. The first side wall 38, second side wall 42 and front wall 44 are assembled and attached to the floor 36 in a conventional manner, defining the box portion 26. The pair of stringers 46, longitudinal ribs 48 and transversal ribs 52 are positioned on the box portion 26 and welded or bolted in place to define the skeletal structure 28.

A body support assembly 54 having first and second body support members 56,58 is manufactured separately from the dump body 12. During manufacture of the body support assembly 54 the bores 112 of the first and second body support members 56,58 are machined to insure alignment along a single axis 118.

After the box portion 26 and skeletal structure 28 have been attached to the dump body 12 the body support assembly 54 positioned on the outside surface 34 of the dump body 12. The body support assembly 54 is next attached to the dump body 12 via weld, bolts or other conventional fastening methods. The dump body 12 is now complete and ready for installation on the frame 14 of the truck 10.

In the case of a dump body 12 requiring replacement of either of the first and second body support members 56,58, the damaged body support assembly 54 is simply removed from the dump body 12 using conventional techniques. A new body support assembly 54 is next positioned on the dump body 12 and attached using conventional techniques, such as welding or bolting.

The above described invention allows large dump bodies 12 to be manufactured or repaired without requiring that the entire dump body 12 be transported to a specialized machining area for secondary machining operations.

What is claimed is:

1. A body support assembly for an off-highway truck, said body support assembly comprising:
a base member having a first side portion, a second side portion and a connecting member extending therebetween, said base member being adapted to engage an outside surface of a dump body;
a first body support member including a pin bore, said first body support member being attached to said base member at a position nearest said first side portion; and
a second body support member including a second pin bore, said second body support member being attached to said exterior surface of said base member at a position nearest said second side portion, wherein said second body support member is fixedly attached to said base member in a manner providing alignment of said pin bores about a single axis.

2. The body support assembly of claim 1 including at least one stringer portion.

3. The body support assembly of claim 1 including an transversal rib positioned between said first and second body support member.

4. The body support assembly of claim 1 including at least one gusset attached to said body support assembly.

5. The body support assembly of claim 1 being attached to a dump body by a plurality of bolts.

6. The body support assembly of claim 1, wherein said body support assembly is constructed of at least one casting.

7. The body support assembly of claim 1 wherein said base member includes a steel plate.

8. The body support assembly of claim 1 wherein said base member 76 includes at least one of a stringer portion and an transversal rib.

9. An off-highway truck comprising:
a frame;
a plurality of wheels, rotatably mounted on said frame;
an engine and drive train positioned on said frame, said engine and drive train being drivingly connected to said plurality of wheels;
a dump body being pivotally attached to said frame, said dump body including box portion having an inside surface and an outside surface; and
a body support assembly attached to said box portion of said dump body, said body support assembly including a base member having a first side portion, a second side portion and an exterior surface extending therebetween, a first body support member having a pin bore, said first body support member being fixedly attached to said base member at a position nearest said first side portion, a second body support member including a pin bore, said second body support member being fixedly attached to said base member at a position nearest said second side portion, wherein said second body support member is fixedly attached to said base member in a manner providing alignment of said pin bore of said first body support member and said pin bore of said second body support member about a single axis.

10. The off-highway truck of claim 9 including at least one stringer portion attached to said exterior surface of said base member.

11. The off-highway truck of claim 9 including an transversal rib positioned to traverse said base member.

12. The off-highway truck of claim 9 including at least one gusset attached to said body support assembly.

13. The off-highway truck of claim 9 being attached to said dump body by a plurality of bolts.

14. The off-highway truck of claim 9 wherein said base member includes a steel plate.

15. The off-highway truck of claim 9 wherein said base member includes at least one stringer portion and an transversal rib.

16. A method for repairing one of a first or second body support member on an off-highway truck dump body comprising:
removing a first and second body support member from said dump body;
providing a new body support assembly, said body support assembly including new first and second body support members;
preparing said dump body to receive said new body support assembly; and
attaching said new body support assembly to said dump body.

17. The method of repairing one of a first or second body support member of claim 16, wherein said step of preparing said dump body to receive said body support assembly includes removing a stringer portion or transversal rib.

18. The method of repairing one of a first or second body support member of claim 16, wherein said step of attaching said body support assembly includes welding said body support assembly to said dump body.

19. The method of repairing one of a first or second body support member of claim 16, wherein said step of attaching said body support assembly includes bolting said body support assembly to said dump body.
